(19) United States
(12) Patent Application Publication
(10) Pub. No.: US 2019/0207943 A1
(43) Pub. Date: Jul. 4, 2019

(54) DATA GUARD SYSTEM

(71) Applicant: Keyp GmbH, Munich (DE)

(72) Inventors: Markus Edmaier, Kasti (DE); Stephanie Feidmann, München (DE); Simon Mang, München (DE); Maximilian Möhring, München (DE)

(21) Appl. No.: 16/327,529

(22) PCT Filed: Aug. 22, 2017
(86) PCT No.: PCT/EP2017/071072

§ 371 Date: Feb. 22, 2019

(30) Foreign Application Priority Data
Aug. 22, 2016 (EP) 16185149.8
Aug. 22, 2016 (EP) 16185166.2

(51) Int. Cl. H04L 29/06; G06F 21/62; H04L 9/32; H04W 12/08; H04W 12/12

(52) U.S. Cl. CPC H04L 63/10; G06F 21/62; H04L 9/3236; H04W 12/08; H04W 12/12; H04L 9/3247

(57) ABSTRACT

The present disclosure relates to a guard system including a guard interface, a data guard, and a decider. The guard interface receives an access request relating to a data token, the access request including first information data representing a first information content. The data guard extracts an attribute relating to the information element from the information data and applies an access rule governing access to the data token to the extracted attribute to obtain a current verification result. The decider determines whether the current verification result matches a pre-stored verification result obtained from applying the access rule to a previously extracted attribute from a previous access request. If the current verification results does not match the pre-stored verification result, the decider outputs a warning message.

### CROSS-REFERENCE TO RELATED APPLICATIONS

The present application is a national stage entry of PCT/EP2017/071072, filed 22 Aug. 2017, and entitled “DATA GUARD SYSTEM”. PCT/EP2017/071072 claims the benefit of European Patent Application EP 16185166.2, filed 22 Aug. 2016, and entitled “DATA GUARD SYSTEM”, and European Patent Application EP 16185149.8, filed 22 Aug. 2016, and entitled “DATA GUARD SYSTEM”.

### TECHNICAL FIELD

In general, the present disclosure relates to the field of communication systems. In particular, the present disclosure relates to systems, devices and methods for detecting unauthorized access to data in communication systems.

### BACKGROUND

Data communication over a variety of networks, such as Internet protocol (IP) networks, smartphones or computers has extremely increased over recent years. The affordability and availability of smartphones, computers, or other network access devices has made their use prevalent in a variety of applications.

As access to Internet and other communication networks becomes easier and easier, these networks are increasingly used for applications involving the transfer of data such as images, audio, video and text. For example, data for computer software, music, video, and other applications can be requested and delivered via Internet. The number of network subscribers, data providers, and requests by those subscribers for data transfer and other content is growing very fast. However, the limitations of current systems can restrict the ability to meet the demand in a reliable, secure, efficient and affordable manner. In particular, a challenge to network data transfer involves the management of media rights associated with digital rights management. For example, in order to inhibit and/or prevent fraudulent behavior, such as copying, distribution or other unauthorized use of data, security precautions have to be taken.

Thus, there is a need for improved systems, devices and methods for detecting unauthorized to data in communication systems.

### SUMMARY

It is an object of the disclosure to provide for improved systems, devices and methods for detecting unauthorized access to data in communication systems.

The foregoing and other objects are achieved by the subject matter of the independent claims. Further implementation forms are apparent from the dependent claims, the description and the figures.

According to a first aspect the disclosure relates to a data guard system for detecting unauthorized access to a data token of a plurality of data tokens by a requesting communication entity, the data guard system comprising: a guard interface being configured to receive from the requesting communication entity an access request requesting an access to the data token, the access request comprising first information data representing a first information content, a data guard with an access rule for ruling the access to the data token, the data guard being configured to extract an attribute relating to the information content from the information data and to apply the access rule to the extracted attribute to obtain a current verification result, and a decider being configured to determine whether the current verification result matches with a pre-stored verification result, the pre-stored verification result resulting from applying the access rule to a previously extracted attribute from a previously received access request from the requesting communication entity, the previously received access request comprising second information data representing a second information content, the decider being configured to issue a warning message indicating the unauthorized access if the current verification result does not match with the pre-stored verification result.

An advantage of the disclosure is that storing the verification result allows the data guard system to perform authentication and matching of the requesting communication entity in one step, because, in such a way, the data guard system can save metadata of every “authentication chain” and data token with a time stamp depending on the requesting communication entity. While performing the operations allowing to obtain the current verification result, the data guard system can perform a matching with historic guard metadata (“reaction chain”) concerning the requesting communication entity in order to, for example, detect potential fraud or to recommend information or data token to the requesting communication entity. While the aim of the authentication is to prevent a fraudulent behavior of the requesting communication entity, the aim of matching is to provide the requesting communication entity with suggestions of content that could match its interests.

In an implementation form the guard interface is configured to receive from the requesting communication entity the previous access request requesting an access to the data token, wherein the data guard is configured to extract an attribute from the second information data to obtain the previously extracted attribute and to apply the access rule to the previously extracted attribute to obtain the previous verification result.

In an implementation form the information content is represented by a data stream, and the data guard is configured to extract the respective attribute from the information content.

In an implementation form the data guard is configured to identify the information content in order to extract the respective attribute.

In an implementation form the data guard is configured to extract a frequency spectrum of the information content to obtain the respective attribute.

In an implementation form the information content is a graphical information, in particular a picture or a video, or an audio information, in particular a sound file, or a text information.

In an implementation form the decider is configured to compare or to correlate the current verification result to the previous verification result to determine whether the current verification result matches with the previous verification result.

In an implementation form the decider is configured to determine that the current verification result does not match with the pre-stored verification result if the current verification result differs from the previous verification result, or to determine that the current verification result matches with the pre-stored verification result if the pre-stored verification result equals the current verification result.

In an implementation form the decider is configured to compare a plurality of previous verification results with the current verification result and to determine that the current verification result does not match with the pre-stored verification result if the pre-stored verification result differs from the majority of the previous verification results, or to determine that the current verification result matches with the pre-stored verification result if the pre-stored verification result equals the majority of the previous verification results.

In an implementation form the previous verification result comprises a plurality or result entries, in particular binary result entries, forming a previous result vector, wherein the current verification result comprises a plurality or result entries, in particular binary result entries, forming a current result vector, and wherein the decider is configured to compare the result entries of the previous result vector with the result entries of the current result vector or to correlate the previous result vector with the current result vector or to subtract the previous result vector from the current result vector to determine whether the current verification result does not match with the pre-stored verification result.

In an implementation form the data token is formed by digital data or the data token is formed by digital access data for accessing to digital data, in particular to a digital data space forming a digital group.

In an implementation form the data guard system is formed by a computer executable code, the computer executable code being signed with a digital signature, in particular with a Hash value generated upon the bases of the computer executable code.

According to a second aspect the disclosure relates to a data guard method for detecting unauthorized access to a data token of a plurality of data tokens by a requesting communication entity. The data guard method comprises the following steps: receiving from the requesting communication entity an access request requesting an access to the data token, the access request comprising first information data representing a first information content, extracting an attribute relating to the information content from the information data, applying an access rule to the extracted attribute to obtain a current verification result, the access rule ruling the access to the data token, and determining whether the current verification result matches with a pre-stored verification result, the pre-stored verification result resulting from applying the access rule to a previously extracted attribute from a previously received access request from the requesting communication entity, the previously received access request comprising second information data representing a second information content, the decider being configured to issue a warning message indicating the unauthorized access if the current verification result does not match with the pre-stored verification result.

According to a third aspect the disclosure relates to a communication device comprising the data guard system according to the first or second aspect and any one of the implementation forms thereof and a communication interface, the communication interface being configured to receive the access request over a communication network, and to pass the received access request to the guard interface.

In an implementation form the communication interface is a wireless interface, in particular a LTE interface or a UMTS interface or a WiFi interlace or a NFC interface or an infrared interface.

In an implementation form the data guard system is a software code which can be downloaded from a server according to rules defined by an owner of the software code.

According to a fourth aspect the disclosure relates to a data guard system for guarding access to data token of a plurality of data by a requesting communication entity, the data guard system comprising: a guard interface being configured to receive from the requesting communication entity an access request requesting an access to the data token, the access request comprising information data representing an information content, and a data guard with an access rule for ruling the access to the data token, the data guard being configured to extract an attribute relating to the information content from the information data and to determine whether the extracted attribute fulfills the access rule, wherein the data guard is further configured to output a first output signal if the extracted attribute fulfills the access rule or to output a second output signal if the extracted attribute violates the access rule.

In an implementation form the data guard system further comprises another data guard with another access rule for ruling the access to the data token, the other access rule being different from the access rule, the other data guard being configured to extract another attribute relating to the information content from the information data and to determine whether the other extracted attribute fulfills the other access rule, wherein the further data guard is further configured to output a first output signal if the other extracted attribute fulfills the other access rule or to output a second output signal if the other extracted attribute violates the other access rule.

In an implementation form the information content is represented by a data stream, and the data guard is configured to extract the respective attribute from the information content.

In an implementation form the data guard is configured to identify the information content in order to extract the respective attribute.

In an implementation form the data guard is configured to extract a frequency spectrum of the information content to obtain the respective attribute.

In an implementation form the respective data guard is configured to compare the respective extracted attribute to a reference attribute in order to determine whether the respective extracted attribute fulfills the respective rule.

In an implementation form the data guard system further comprises a decider being configured to output an enable signal for enabling the requesting communication entity to access to the data token if each data guard of the data guard system outputs the first signal, or to output a disable signal if the data guard outputs the second signal.

In an implementation form the guard interface is configured to establish a communication channel between the requesting communication entity and the data token if the decider outputs the enable signal, or to reject the access request if the decider outputs the disable signal.

In an implementation form the guard interface is configured to output a video signal representing the enable signal for displaying by a display, or the data guard system comprises a display for displaying the enable signal.

In an implementation form the data guard system is formed by a computer executable code, the computer executable code being signed with a digital signature, in particular with a Hash value generated upon the bases of the computer executable code.

In an implementation form the guard interface is a HTML interface or a HTTP interface or a GUI interface or a API interface.

According to a fifth aspect the disclosure relates to a data guard method for guarding access to data token of a plurality of data by a requesting communication entity. The data guard method comprises the following steps: receiving from the requesting communication entity an access request requesting an access to the data token, the access request comprising information data representing an information content, extracting an attribute relating to the information content from the received information data, determining whether the extracted attribute fulfills an access rule, and outputting a first output signal if the extracted attribute fulfills the access rule or outputting a second output signal if the extracted attribute violates the access rule.

According to a sixth aspect the disclosure relates to a communication device. The communication device comprises the data guard system of the first aspect and one of the implementation forms thereof and a communication interface, the communication interface being configured to receive the access request over a communication network, and to pass the received access request to the guard interface.

In an implementation form the communication interface is a wireless interface, in particular a LTE interface or a UMTS interface or a WiFi interface or a NFC interface or an infrared interface.

In an implementation form the communication device is configured to execute the data guard method of the second aspect.

In an implementation form the data guard system is a software code which can be downloaded from a server according to rules defined by an owner of the software code.

In an implementation form the software code is a Java or an objective-C code.

The principles described herein can be implemented in hardware and/or software.

The implementation forms of all aspects of the principles described herein can be combined with each other.

### BRIEF DESCRIPTION OF THE DRAWINGS

Further examples of the principles described herein will be described with respect to the following figures, wherein:

FIG. 1 shows a schematic diagram illustrating a communication system comprising a data guard system and a requesting communication entity communicating over a communication channel according to an example;

FIG. 2 shows a schematic diagram illustrating a communication flow between a data guard system and a user of a requesting communication entity according to an example;

FIG. 3a shows exemplary entries of a table containing information related to a data guard system according to an example;

FIG. 3b shows exemplary entries of a table containing information related to a data guard system according to an example;

FIG. 4 shows two exemplary tables containing information related to a data guard system according to an example;

FIG. 5 shows a schematic diagram of a data guard method for detecting unauthorized access to a data token of a plurality of data by a requesting communication entity according to an example;

FIG. 6 shows a schematic diagram of a communication system comprising a communication device and a requesting communication entity communicating over a communication channel according to an example;

FIG. 7 shows a schematic diagram of a data guard method for guarding access to data token of a plurality of data by a requesting communication entity according to an example; and

FIG. 8 shows a schematic diagram of a communication system comprising a communication device and a requesting communication entity communicating over a communication channel according to an example.

In the figures, identical reference signs will be used for identical or functionally equivalent features.

### DETAILED DESCRIPTION

In the following description, reference is made to the accompanying drawings, which form part of the disclosure, and in which are shown, by way of illustration, specific aspects in which the principles described herein may be implemented. It will be appreciated that the principles described herein may be placed in other aspects and that structural or logical changes may be made without departing from the scope of the principles. The following detailed description, therefore, is not to be taken in a limiting sense, as the scope of the invention is defined by the appended claims.

For instance, it will be appreciated that a disclosure in connection with a described method will generally also hold true for a corresponding device or system configured to perform the method and vice versa. For example, if a specific method step is described, a corresponding device may include a unit to perform the described method step, even if such unit is not explicitly described or illustrated in the figures.

Moreover, in the following detailed description as well as in the claims, examples with functional blocks or processing units are described, which are connected with each other or exchange signals. It will be appreciated that the principles described herein also cover examples which include additional functional blocks or processing units that are arranged between the functional blocks or processing units of the examples described below.

Finally, it is understood that the features of the various exemplary aspects described herein may be combined with each other, unless specifically noted otherwise.

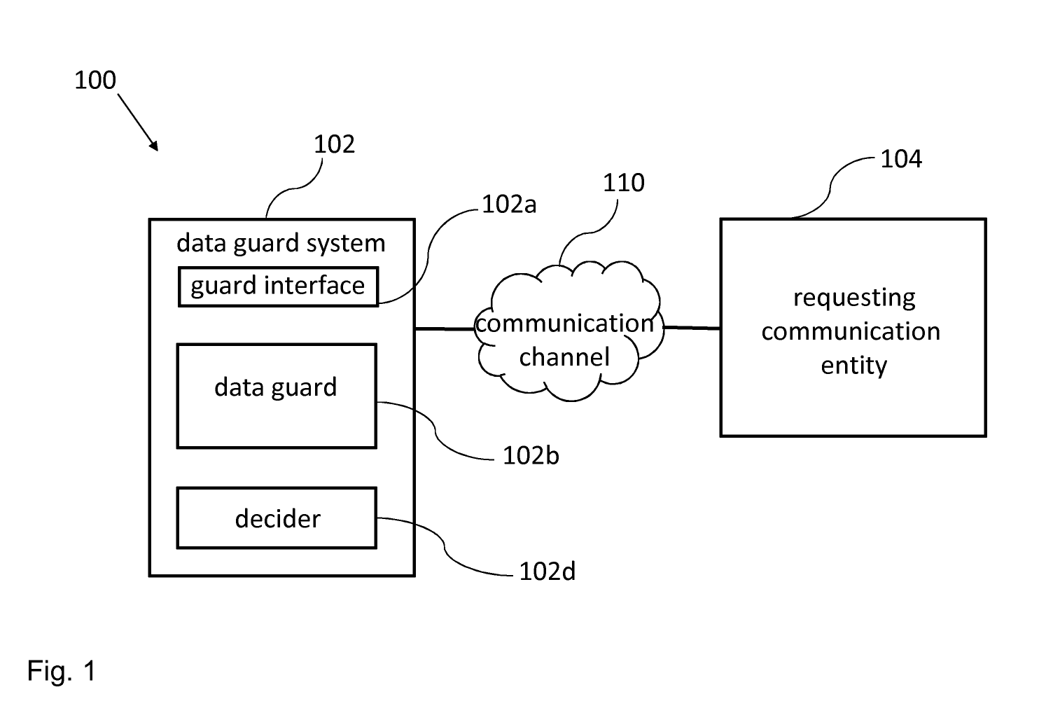

FIG. 1 shows a schematic diagram illustrating a communication system 100 comprising a data guard system 102 and a requesting communication entity 104 communicating over a communication channel 110 according to an example.

In an example the data guard system 102 can be used for detecting unauthorized access to a data token of a plurality of data tokens by the requesting communication entity 104. The data guard system 102 can comprise a guard interface 102a being configured to receive from the requesting communication entity 104 an access request requesting an access to the data token, the access request comprising first information data representing a first information content. Furthermore, the data guard system 102 can comprise a data guard 102b with an access rule for ruling the access to the data token, wherein the data guard 102b can be configured to extract an attribute relating to the information content from the information data and to apply the access rule to the extracted attribute to obtain a current verification result. Moreover, the data guard system 102 can comprise a decider 102d, which can be configured to determine whether the current verification result matches with a pre-stored verification result, the pre-stored verification result resulting from applying the access rule to a previously extracted attribute from a previously received access request from the requesting communication entity 104, the previously received access request comprising second information data representing a second information content. The decider 102d can also be configured to issue a warning message indicating the unauthorized access if the current verification result does not match with the pre-stored verification result.

In an example the respective information content can be a meta content, in particular a geographical location of the requesting communication entity 104 or personal information relating to a user 104a of the requesting entity 104, and the respective data guard 102b can be configured to extract the respective meta content to obtain the respective attribute.

In another example the decider 102d can be configured to output an enable signal if the current verification result matches with the pre-stored verification result.

Moreover, in a further example, the decider 102d can be configured to establish a communication channel between the requesting communication entity 104 and the data token if the decider 102d outputs the enable signal, or to reject the access request if the decider 102d outputs the warning signal.

In an example the guard interface 102a can be a HTML interface or a HTTP interface or a GUI interface or a API interface.

The communication channel 110 can be a wired or a wireless communication channel. In an example the data guard system 102 can comprise the guard interface 102a, which can be configured to receive an access request requesting an access to the data token from the requesting communication entity 104, the access request can compare information data representing an information content. Furthermore, the data guard system 102 can comprise the data guard 102b with an access rule for ruling the access to the data token, the data guard 102b can be configured to extract an attribute relating to the information content from the information data and to determine whether the extracted attribute fulfills the access rule. Moreover, the data guard 102b can be configured to output a first output signal if the extracted attribute fulfills the access rule or to output a second output signal if the extracted attribute violates the access rule.

In an example the data guard system 102 can comprise the decider 102d, wherein the decider 102d can be configured to output an enable signal for enabling the requesting communication entity 104 to access to the data token if each data guard 102b of the data guard system 102 outputs the first signal, or to output a disable signal if the data guard 102b outputs the second signal.

The communication channel 110 can be a wired or a wireless communication channel.

In an example the respective information content of the data guard 102b can be a meta content, in particular a geographical location of the requesting communication entity 104 or personal information relating to a user of the requesting communication entity 104, and the data 102b guard can be configured to extract the respective meta content to obtain the respective attribute.

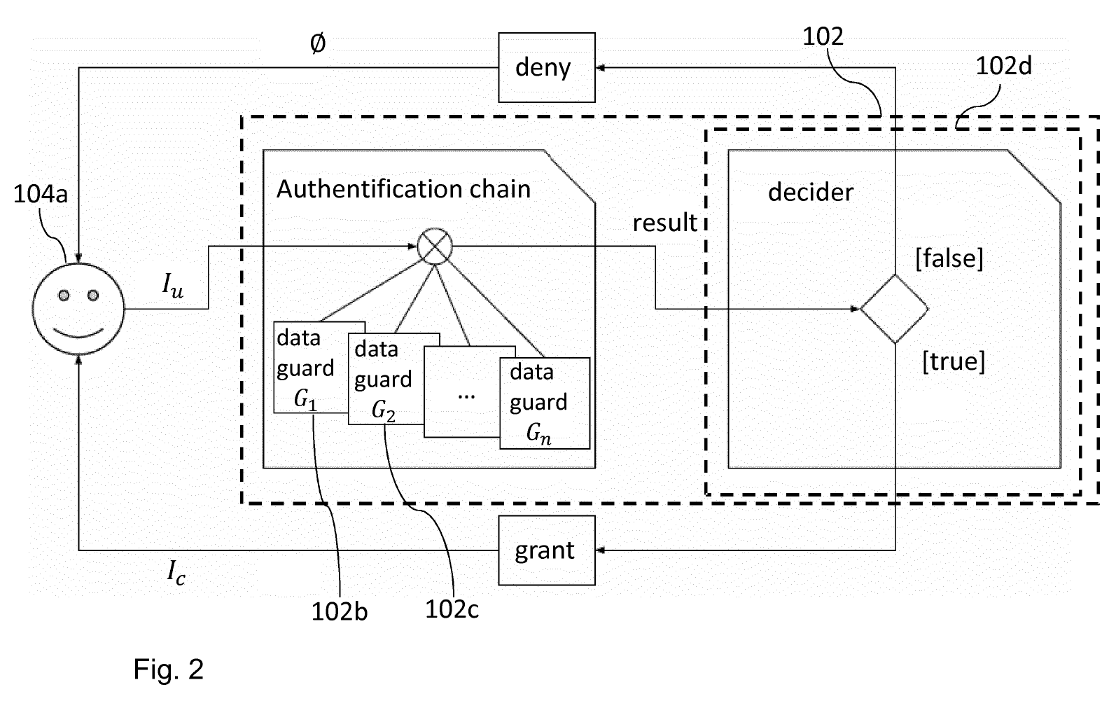

FIG. 2 shows a schematic diagram illustrating a communication flow between a data guard system 102 and a user 104a of a requesting communication entity 104 according to an example.

In this example the user 104a of the requesting communication entity 104 request access to a data token (e.g., picture, text or video) I_{c}, wherein the data token is guarded by the data guard system 102, and provides information data Iᵤ to the data guard system 102. Firstly, the data guards (e.g. 102b and 102c) extract attributes from the provided information data Iᵤ (e.g. objects in a picture) of the requesting communication entity 104. Afterwards, each of the data guards (e.g., 102b and 102c) applies a set of defined rules G₁(I_{U}), G₂(I_{U}), . . . , Gₙ(I_{U}) on those attributes and a combined “authentication chain” or current verification result r is obtained:

r=G₁(I_{U})ΛG₂(I_{U})Λ . . . ΛGₙ(I_{U}),

wherein the symbol Λ denotes a logical AND operator. Then, the current verification result r is passed to the decider 102d. Based on the current verification result r, the decider 102d can determine whether the current verification result r matches with a pre-stored verification result. If the current verification result r matches with the pre-stored verification result, then the decider 102d grants access to the requested data token I_{c} to the requesting communication entity 104, otherwise it denies access to the requested data token I_{c}.

Storing the verification result r has the advantage of allowing the data guard system 102 to perform authentication and matching of the requesting communication entity 104 in one step, because, in such a way, the data guard system 102 saves metadata of every “authentication chain” and data token with a time stamp depending on the requesting communication entity 104. While performing the operations allowing to obtain the current verification result r, the data guard system 102 can perform a matching with historic guard metadata (“reaction chain”) concerning the requesting communication entity 104 in order to, for example, detect potential fraud or to recommend information or data token to the requesting communication entity 104. While the aim of the authentication is to prevent a fraudulent behavior of the requesting communication entity 104, the aim of matching is to provide the requesting communication entity 104 with suggestions of content that could match its interests.

Advantageously, by means of the aforementioned “reaction chain”, the data guard system 102 can save the following metadata related to the requesting communication entity 104: data token type and headline, access rule type or guard type, task and result, time stamp, amount of access rules or guards per data token, the last showing the relationship between the requesting communication entity 104 and a particular data token.

Furthermore, another advantage of the data guard system 102 is that it allows to encrypt personal data related to requesting communication entity 104, while still being able to perform authentication and matching, even if the profile of the user 104a of the requesting communication entity 104 as well as the information itself (data token) can be encrypted.

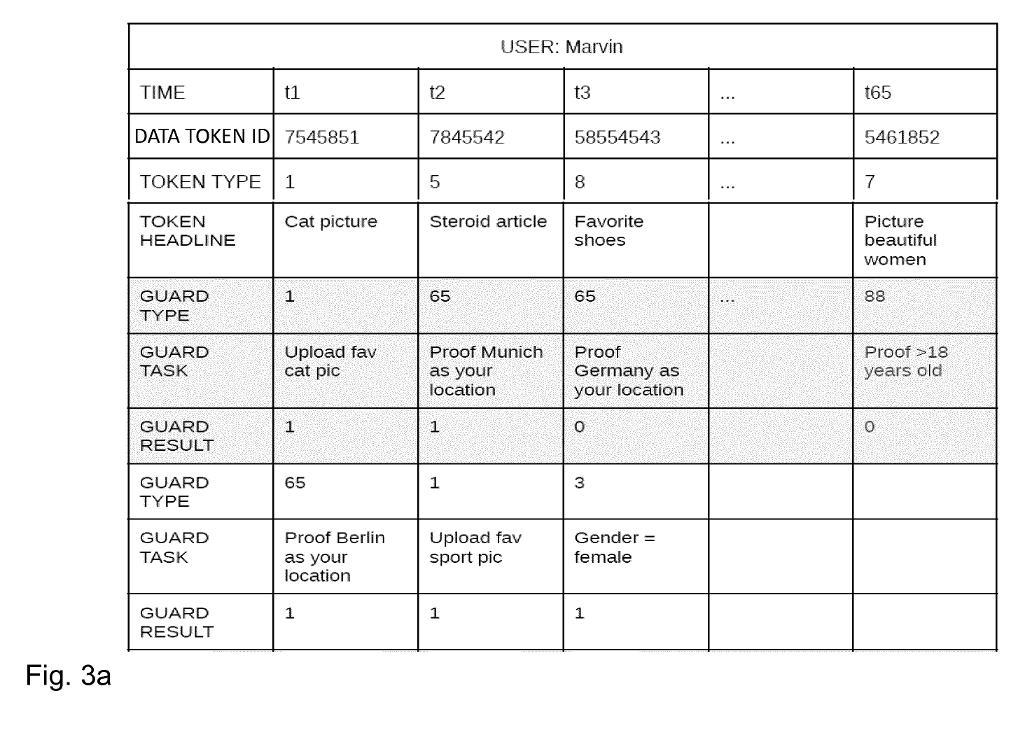

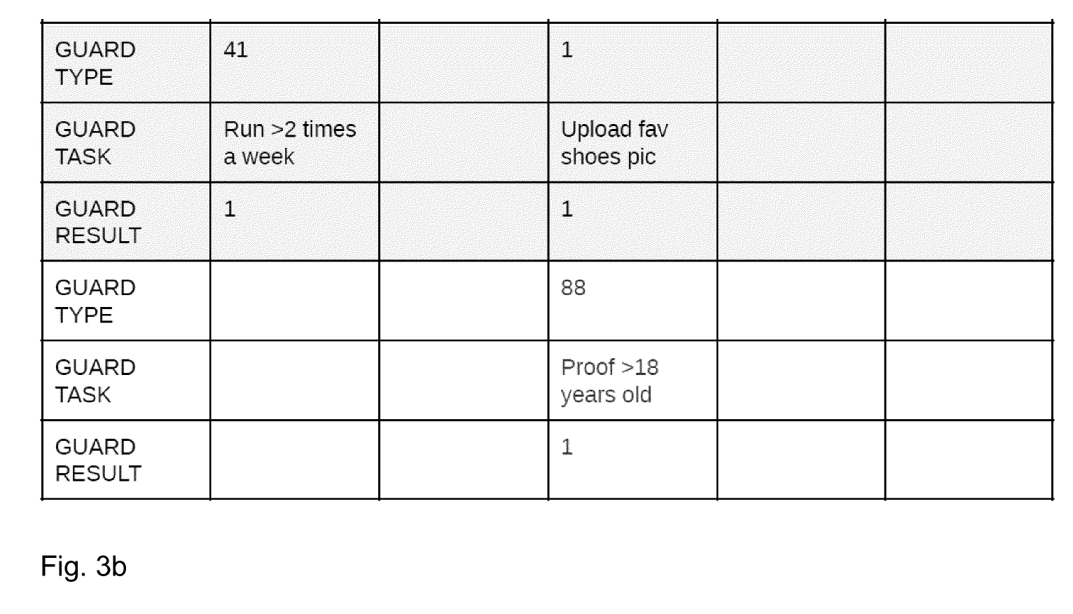

FIGS. 3a and 3b show exemplary entries of a table containing information related to a data guard system 102 according to an example. In particular, the table shows an example of a fraudulent behavior of the user 104a of the requesting communication entity 104. In fact, in this example, the user 104a has a “reaction chain” with 65 entries and wants to solve the access rule or guard 88 (age guard) in order to access the data token 7 (picture token). The data guard system 102 identifies the potential fraudulent behavior, since in the reaction chain of the user 104a there is a logical error concerning the age guard. As it is shown in the table in FIG. 3b, at time t3 the user 104a proved to be older than 18 years and this means that it cannot be under 18 years at time t65 (which is after t3) as shown in FIG. 3a.

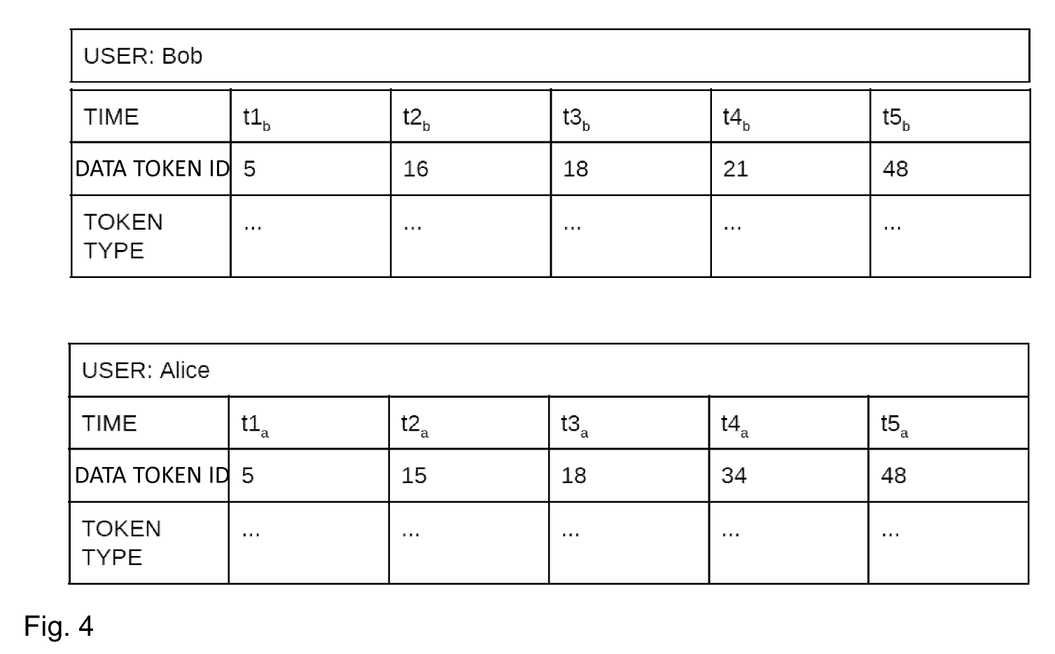

FIG. 4 shows two exemplary tables containing information related to a data guard system 102 according to an example. In particular, an example of a reaction chain, that is of a chain of reactions of a user 104a of the requesting communication entity 104 to a particular data token is illustrated, showing what data tokens the user 104a is interested in. The reaction chain can be seen as a result vector which may be compared to the reaction chains of other users, wherein similar result vectors of different users will form smaller angles. The differences between the most similar or most matching result vectors can be used from the data guard system 102 to make suggestions to other users. For example, the user Alice in FIG. 4 reacted to the data tokens 5, 15, 18, 34 and 48, while the user Bob in FIG. 4 reacted to data tokens 5, 16, 18, 21 and 48. Since the difference between these result vectors is small, they can be considered similar. In an example of the data guard system 102, Bob can receive suggestions from the data guard system 102 containing data tokens 15 and 34, while Alice can receive data tokens 16 and 31.

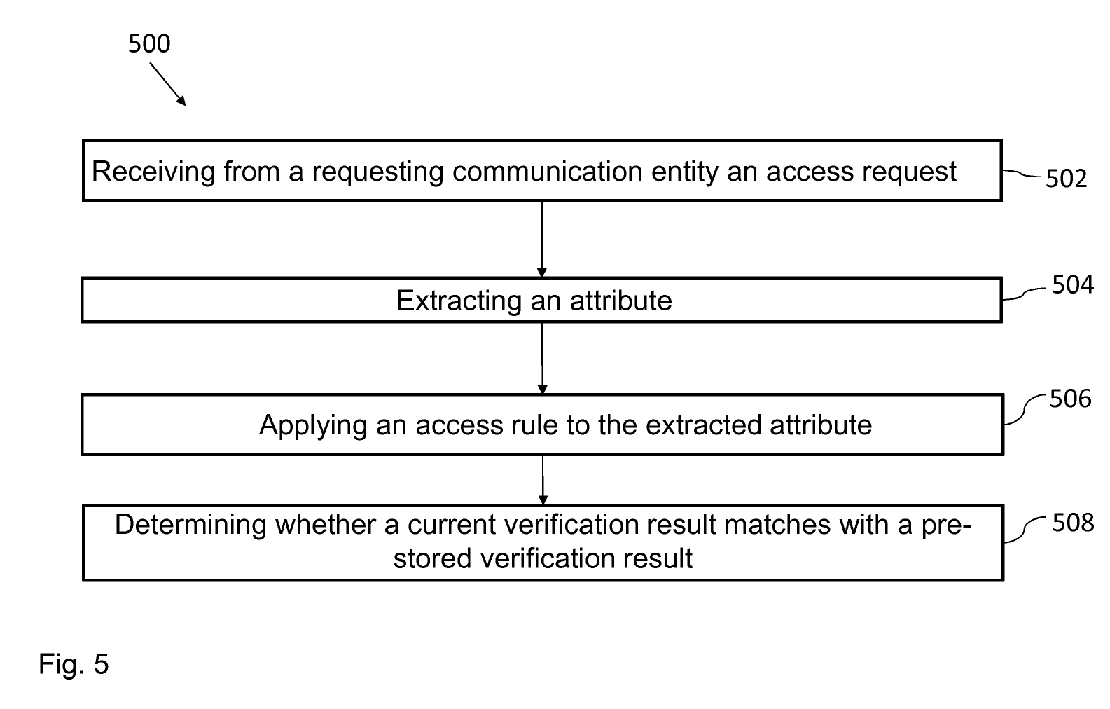

FIG. 5 shows a schematic diagram of a data guard method 500 for detecting unauthorized access to a data token of a plurality of data by a requesting communication entity 104 according to an example. The data guard method 500 comprises the steps of:

Receiving 502 from the requesting communication entity 104 an access request requesting an access to the data token, the access request comprising first information data representing a first information content;

Extracting 504 an attribute relating to the information content from the information data;

Applying 506 an access rule to the extracted attribute to obtain a current verification result, the access rule ruling the access to the data token; and

Determining 508 whether the current verification result matches with a pre-stored verification result, the pre-stored verification result resulting from applying the access rule to a previously extracted attribute from a previously received access request from the requesting communication entity 104, the previously received access request comprising second information data representing a second information content, the decider 102d being configured to issue a warning message indicating the unauthorized access if the current verification result does not match with the pre-stored verification result.

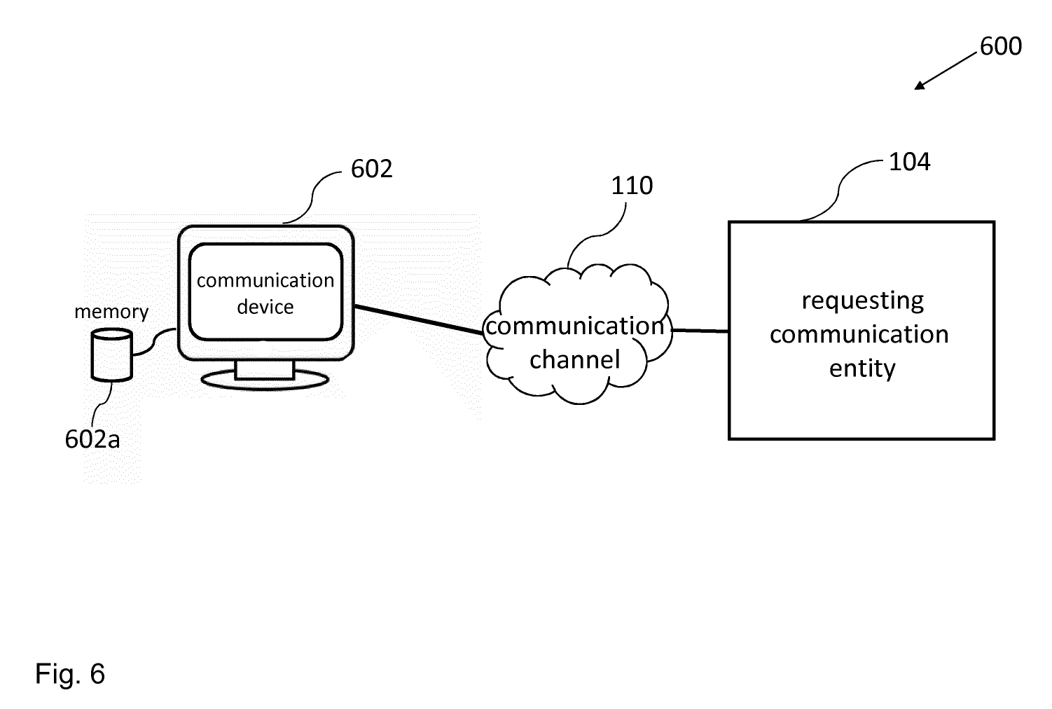

FIG. 6 shows a schematic diagram of a communication system 600 comprising a communication device 602 and a requesting communication entity 104 communicating over a communication channel 110 according to an example. The communication device 602 can comprise the data guard system 102 and a communication interface, the communication interface being configured to receive the access request over the communication channel 110, and to pass the received access request to the guard interface 102a of the data guard system 102.

In an example the data guard system 102 is formed by an executable software code, and the communication device 602 comprises a processor being configured to execute the executable software code. In an example the computer executable code can be signed with a digital signature. Signing the executable code with a digital signature has the advantage of allowing the processor of the communication device 602 to identify the signature and to verify that the executable code has not been modified since it was signed. In such a way, the executable code can be protected by the digital signature, because the digital signature becomes invalid if any part of the executable code is changed. Signing the executable code can also be used in combination with an identity of the data guard system 102, provisioning profile, or entitlements in order to ensure at least the following aspects:

the data guard system 102 can be built and signed by trusted entities;

the data guard system 102 can run on designated development devices; and the data guard system 102 can be configured to avoid services that the entrusted entity did not add to the data guard system 102.

Furthermore, signing the executable code with a digital signature can also allow the entrusted entity to remove or redesign the data guard system 102.

In an example the communication device 602 can comprise a memory 602a for access rule storage and the data guard system 102 can be configured to read out the respective access rule from the memory 602a.

In an example the communication device 602 can be a smartphone or a personal computer.

In an example the communication device 602 can be configured to execute the data guard method 500.

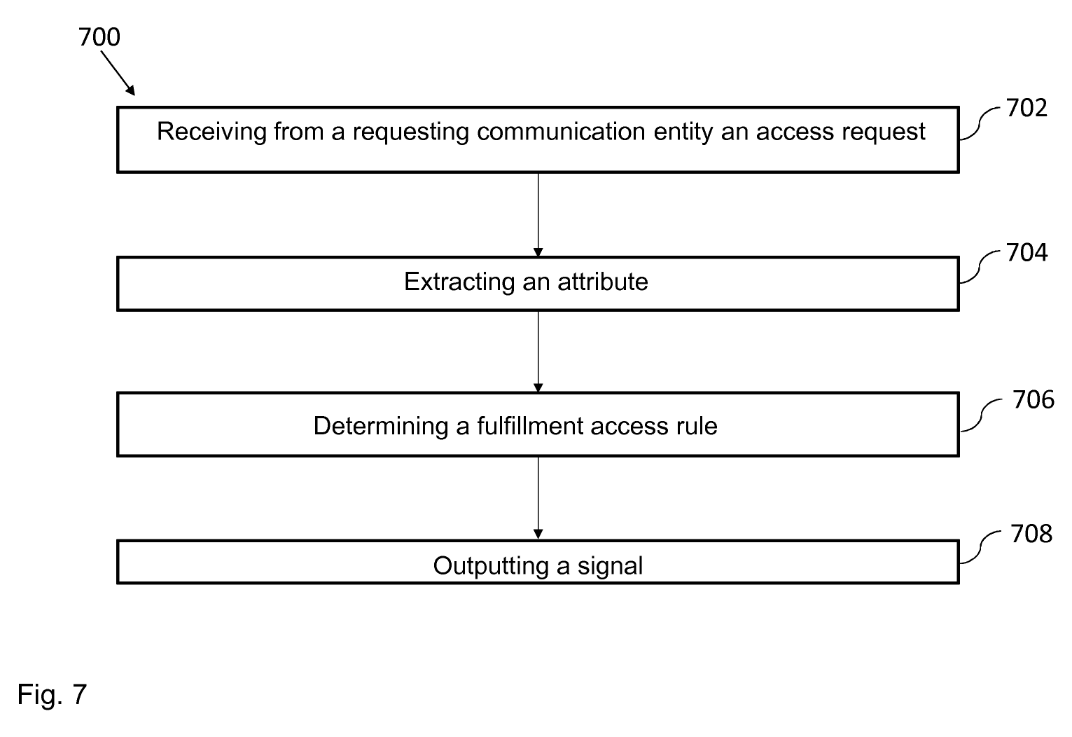

FIG. 7 shows a schematic diagram of a data guard method 700 for guarding access to data token of a plurality of data by a requesting communication entity 104 according to an example. In an example the method 700 can comprise the step of:

Receiving 702 from the requesting communication entity 104 an access request requesting an access to the data token, the access request comprising information data representing an information content;

Extracting 704 an attribute relating to the information content from the received information data;

Determining 706 whether the extracted attribute fulfills an access rule; and

Outputting 708 a first output signal if the extracted attribute fulfills the access rule or outputting a second output signal if the extracted attribute violates the access rule.

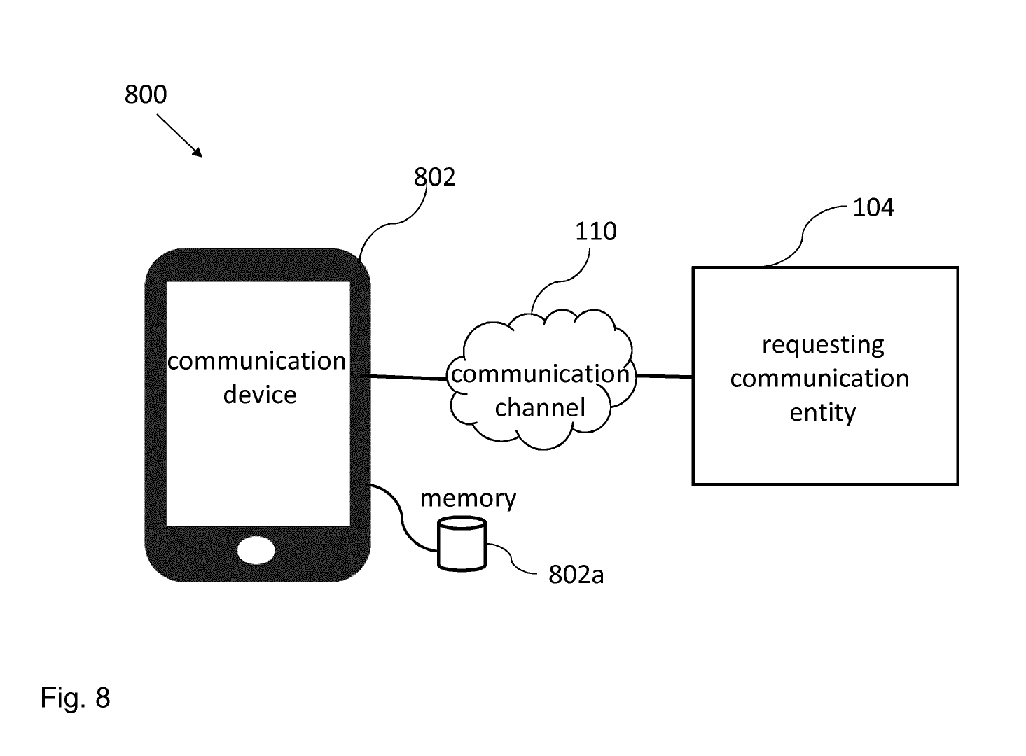

FIG. 8 shows a schematic diagram of a communication system 800, comprising a communication device 802 and a requesting communication entity 104 communicating over a communication network or channel 110 according to an example. In an example the communication device 802 can comprise the data guard system 102 and a communication interface, wherein the communication interface can be configured to receive access request over the communication network or channel 110 and to pass the received access request to the guard interface 102a.

The communication channel 110 can be a wired or a wireless communication channel.

In an example the data guard system 102 can be formed by an executable software code, and the communication device 802 can comprise a processor configured to execute the executable software code. In an example the computer executable code can be signed with a digital signature. Signing the executable code with a digital signature has the advantage of allowing the processor of the communication device 802 to identify the signature and to verify that the executable code has not been modified since it was signed. In such a way, the executable code can be protected by the digital signature, because the digital signature becomes invalid if any part of the executable code is changed. Signing the executable code can also be used in combination with an identity of the data guard system 102, provisioning profile, or entitlements in order to ensure at least the following aspects:

the data guard system 102 can be built and signed by trusted entities;

the data guard system 102 can run on designated development devices; and

the data guard system 102 can be configured to avoid services that the entrusted entity did not add to the data guard system 102.

Furthermore, signing the executable code with a digital signature can allow the entrusted entity to remove or redesign the data guard system 102.

In an example the communication device 802 can comprise a memory 802a for access rule storage, and the data guard system 102 can be configured to read out the respective access rule from the memory 802a.

In an example the communication device 802 can be a smartphone or a personal computer.

In another example, the communication device 802 can be configured to execute the data guard method 700.

While a particular feature or aspect of the disclosure may have been disclosed with respect to only one of several implementations or examples, such feature or aspect may be combined with one or more other features or aspects of the other implementations or examples as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art will readily recognize that there are numerous applications of the present disclosure beyond those described herein. While the principles described herein have been described with reference to one or more particular examples, those skilled in the art will recognize that many changes may be made thereto without departing from the scope of the present disclosure. It is therefore to be understood that within the scope of the appended claims and their equivalents, the principles described herein may be practiced otherwise than as specifically described herein.

1. A data guard system for detecting unauthorized access to a data token of a plurality of data tokens by a requesting communication entity, the data guard system comprising:
a guard interface configured to receive from the requesting communication entity an access request requesting access to the data token, the access request comprising first information data representing a first information content;
a data guard configured to extract an attribute relating to the information content from the information data and to apply an access rule to the extracted attribute to obtain a current verification result, wherein the access rule governs access to the data token; and
a decider configured to determine whether the current verification result matches with a pre-stored verification result, the pre-stored verification result resulting from applying the access rule to a previously extracted attribute from a previously received access request from the requesting communication entity, the previously received access request comprising second information data representing a second information content, the decider being configured to issue a warning message indicating the unauthorized access if the current verification result does not match with the pre-stored verification result.

2. The data guard system of claim 1, wherein the guard interface is configured to receive from the requesting communication entity the previous access request, the previous access request requesting access to the data token, wherein the data guard is configured to extract an attribute from the second information data to obtain the previously extracted attribute and to apply the access rule to the previously extracted attribute to obtain the previous verification result.

3. The data guard system of claim 1, wherein the information content is represented by a data stream, and wherein the data guard is configured to extract the respective attribute from the information content.

4. The data guard system of claim 1, wherein the data guard is configured to identify the information content to extract the respective attribute.

5. The data guard system of claim 1, wherein the data guard is configured to extract a frequency spectrum of the information content to obtain the respective attribute.

6. The data guard system of claim 1, wherein the information content comprises one or more of: graphical information, or audio information, or text information.

7. The data guard system of claim 1, wherein the decider is configured to compare or to correlate the current verification result to the previous verification result to determine whether the current verification result matches with the previous verification result.

8. The data guard system of claim 7, wherein the decider is configured to determine that the current verification result does not match with the pre-stored verification result if the current verification result differs from the previous verification result, or to determine that the current verification result matches with the pre-stored verification result if the pre-stored verification result equals the current verification result.

9. The data guard system of claim 1, wherein the decider is configured to compare a plurality of previous verification results with the current verification result and to determine that the current verification result does not match with the pre-stored verification result if the pre-stored verification result differs from a majority of the previous verification results, or to determine that the current verification result matches with the pre-stored verification result if the pre-stored verification result equals a majority of the previous verification results.

10. The data guard system of claim 1, wherein the previous verification result comprises a plurality or result entries forming a previous result vector, wherein the current verification result comprises a plurality or result entries forming a current result vector, and wherein the decider is configured to compare the result entries of the previous result vector with the result entries of the current result vector or to correlate the previous result vector with the current result vector or to subtract the previous result vector from the current result vector to determine whether the current verification result does not match with the pre-stored verification result.

11. The data guard system of claim 1, wherein the data token is formed by digital data or wherein the data token is formed by digital access data for accessing digital data.

12. The data guard system of claim 1, wherein the guard interface, the data guard, and the decider are implemented by computer executable code executed by one or more processors, the computer executable code being signed with a digital signature.

13. A method for detecting unauthorized access to a data token of a plurality of data tokens by a requesting communication entity, the method comprising:
receiving from the requesting communication entity an access request requesting access to the data token, the access request comprising first information data representing a first information content;
extracting an attribute relating to the information content from the information data;
applying an access rule to the extracted attribute to obtain a current verification result, the access rule governing the access to the data token; and
determining whether the current verification result matches with a pre-stored verification result, the pre-stored verification result resulting from applying the access rule to a previously extracted attribute from a previously received access request from the requesting communication entity, the previously received access request comprising second information data representing a second information content; and
issuing a warning message indicating the unauthorized access if the current verification result does not match with the pre-stored verification result.

14. A communication device, comprising:
a guard interface configured to receive from the requesting communication entity an access request requesting access to the data token, the access request comprising first information data representing a first information content;
a data guard configured to extract an attribute relating to the information content from the information data and to apply an access rule to the extracted attribute to obtain a current verification result, wherein the access rule governs access to the data token; and
a decider configured to determine whether the current verification result matches with a pre-stored verification result, the pre-stored verification result resulting from applying the access rule to a previously extracted attribute from a previously received access request from the requesting communication entity, the previously received access request comprising second information data representing a second information content, the decider being configured to issue a warning message indicating the unauthorized access if the current verification result does not match with the pre-stored verification result; and
a communication interface, the communication interface being configured to receive the access request over a communication network and to pass the received access request to the guard interface.

15. The communication device of claim 14, wherein the communication interface is a wireless interface or an infrared interface.

16. The data guard system of claim 6, wherein the graphical information comprises one or more of a picture or a video; or wherein the audio information comprises a sound file.

17. The data guard system of claim 10, wherein the plurality of result entries comprises a plurality of binary results entries.

18. The data guard system of claim 11, wherein the digital access data for accessing digital data comprises digital access data for accessing a digital data space forming a digital group.

19. The data guard system of claim 12, wherein the digital signature comprises a hash value.

20. The communication device of claim 14, wherein the wireless interface comprises one or more of: a Long Term Evolution (LTE) interface, a Universal Mobile Telecommunications service (UMTS) interface, a WiFi interface, or a Near Field Communications (NFC) interface.
